(19) United States
(12) Patent Application Publication
(10) Pub. No.: US 2013/0321502 A1
(43) Pub. Date: Dec. 5, 2013

(54) NOZZLE POSITION ADJUSTING APPARATUS AND METHOD FOR PRINTER

(71) Applicant: HON HAI PRECISION INDUSTRY CO., LTD., New Taipei (TW)

(72) Inventor: KUNG-HUANG TSAI, New Taipei (TW)

(73) Assignee: HON HAI PRECISION INDUSTRY CO., LTD., New Taipei (TW)

(21) Appl. No.: 13/849,650

(22) Filed: Mar. 25, 2013

(30) Foreign Application Priority Data
Jun. 5, 2012 (TW) 101120088

(51) Int. Cl. B41J 2/07

(52) U.S. Cl. CPC B41J 2/07
USPC 347/8

(57) ABSTRACT

A nozzle position adjusting apparatus includes a rack and a shaft. A first and a second electromagnets are mounted on the rack. A nozzle module is mounted on the shaft. A first and a second mounting blocks are mounted on opposite ends of the shaft. The first mounting block includes a first receiving slot in which a first magnet is mounted.

The second mounting block includes a second receiving slot in which a second magnet is mounted. The first electromagnet is inserted in the first receiving slot with like poles of the first electromagnet and the first magnet facing to each other to generate a first repulsive force. The second electromagnet is inserted in the second receiving slot with like poles of the second electromagnet and the second magnet facing to each other to generate a second repulsive force which supports the second mounting block.

### BACKGROUND

1. Technical Field

The present disclosure relates to a position adjusting apparatus, and more particularly to a nozzle position adjusting apparatus for a printer.

2. Description of Related Art

A printer often includes a nozzle to spray ink on a print medium. A distance between the nozzle and the print medium can be adjusted to optimize the printing property. In conventional printers, the nozzle slides on a shaft which is mounted on a base. The nozzle is adjusted by moving the base or the shaft. However, it often needs complex mechanisms to move the base or the nozzle.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a partially exploded and isometric view of an embodiment of a nozzle position adjusting apparatus for a printer.

FIG. 2 is an assembled view of the nozzle position adjusting apparatus of FIG. 1.

FIG. 3 is a flow chart of an embodiment of a nozzle position adjusting method for a print.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

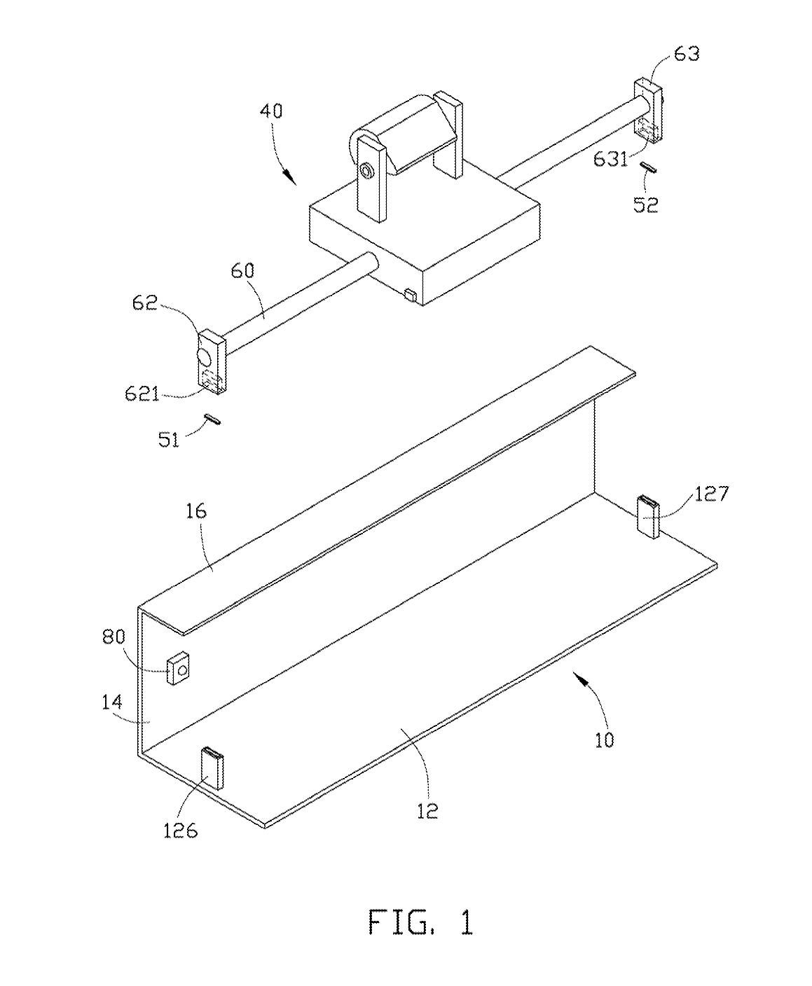

FIG. 1 is a nozzle position adjusting apparatus for a printer in accordance with an embodiment. The position adjusting apparatus includes a rack 10 and a shaft 60. A nozzle module 40 is slidably and rotatably mounted on the shaft 60.

The rack 10 includes a supporting plate 12, a top plate 16, and a connecting plate 14 connected between the supporting plate 12 and the top plate 16. The top plate 16 is parallel to the supporting plate 12. The connecting plate 14 is perpendicular to the supporting plate 12. A first electromagnet 126 and a second electromagnet 127 are mounted on the supporting plate 12. A laser module 80 is mounted on the connecting plate 14.

A first mounting block 62 is mounted on a left end of the shaft 60, and a second mounting block 63 is mounted on a right end of the shaft 60. A first receiving slot 621 is defined in a first bottom portion of the first mounting block 62. A second receiving slot 631 is defined in a second bottom portion of the second mounting block 63. A first magnet 51 can be mounted in the first receiving slot 621. A second magnet 52 can be mounted in the second receiving slot 631. The first electromagnet 126 is adapted to be received in the first receiving slot 621 to match the first magnet 51. The second electromagnet 127 is adapted to be received in the second receiving slot 631 to match the second magnet 52.

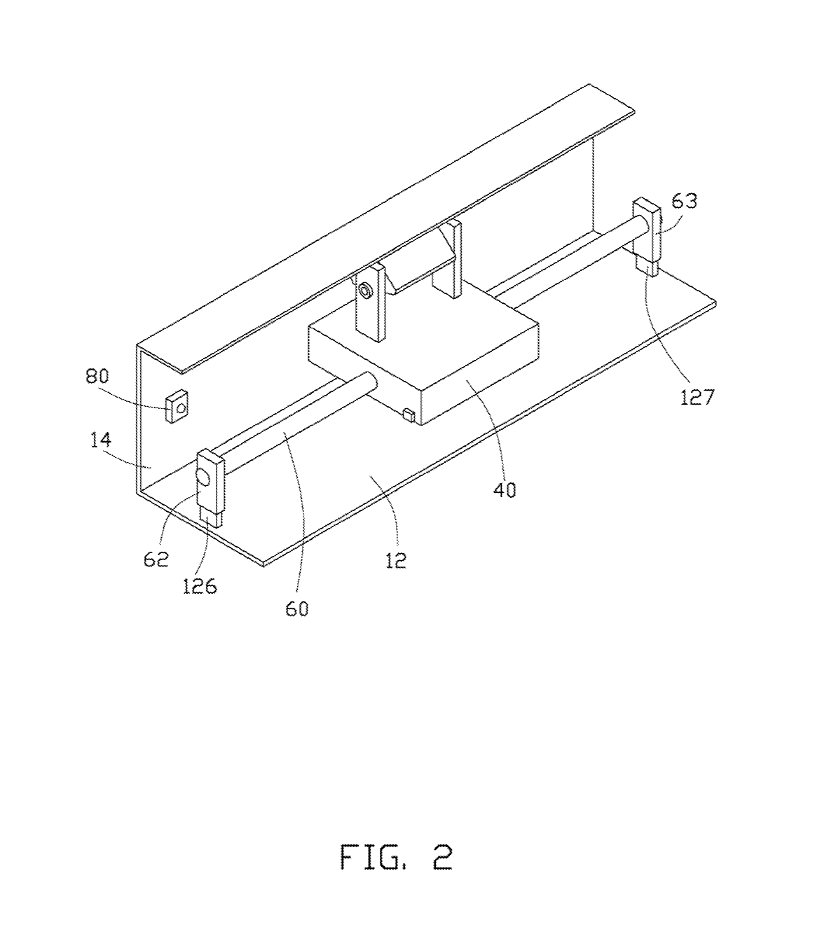

FIGS. 1 and 2 show that in assembly, the first magnet 51 is mounted in the first receiving slot 621 of the first mounting block 62. The second magnet 52 is mounted in the second receiving slot 631 of the second mounting block 63. The first electromagnet 126 is inserted in the first receiving slot 621. Like poles of the first electromagnet 126 and the first magnet 51 face each other. The second electromagnet 127 is inserted in the second receiving slot 631. Like poles of the second electromagnet 127 and the second magnet face each other.

Then, the first electromagnet 126 and a second electromagnet 127 are supplied with power. A first repulsive force is generated between the first electromagnet 126 and the first magnet 51. A second repulsive force is generated between the second electromagnet 127 and the second magnet 52. Therefore, the first mounting block 62 and the second mounting bock 63 can be moved by adjusting the first repulsive force and the second repulsive force. Therefore, heights of the left and right ends of the shaft 60 can be adjusted. The laser module 80 ejects laser to the supporting plate 12 and senses light reflected from the supporting plate 12 to get a height of the nozzle module 40. When the nozzle module 40 slides to the left end of the shaft 60, a height of the left end is gotten. When the nozzle module 40 slides to the right end of the shaft 60, a height of the right end is gotten.

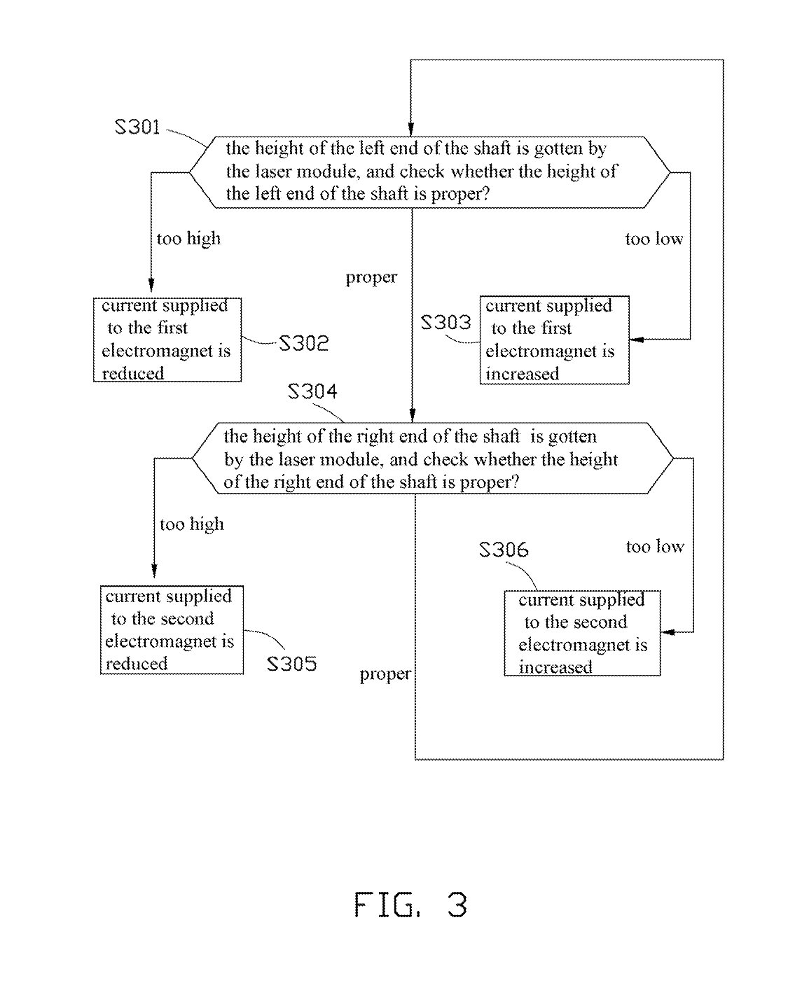

FIG. 3 shows a nozzle position adjusting method. The method includes following steps:

Step S301, the height of the left end of the shaft 60 is gotten by the laser module 40, and to check whether the height of the left end of the shaft 60 is proper. If the left end of the shaft 60 is too high, go to step S302. If the left end of the shaft 60 is too low, go to step S303. If the position of the left end of the shaft 60 is proper, go to step S304.

Step S302, current supplied to the first electromagnet 126 is reduced to lower the first repulsive force, and the first mounting block 62 moves downward.

Step S303, current supplied to the first electromagnet 126 is increased to raiser the first repulsive force, and the first mounting block 62 moves upward.

Step S304, the height of the right end of the shaft 60 is gotten by the laser module 40, and check whether the height of the right end of the shaft 60 is proper. If the right end of the shaft 60 is too high, go to step S305. If the right end of the shaft 60 is too low, go to step S306. If the position of the right end of the shaft 60 is proper, go back to step S301.

Step S305, current supplied to the second electromagnet 127 is reduced to lower the second repulsive force, and the second mounting block 63 moves downward.

Step S306, current supplied to the second electromagnet 127 is increased to raiser the second repulsive force, and the second mounting block 62 moves upward.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A nozzle position adjusting apparatus for a printer, comprising:
a rack, a first electromagnet and a second electromagnet mounted on the rack;
a shaft with a nozzle module mounted thereon, a first mounting block mounted on an end of the shaft, a second mounting block mounted on another end of the shaft, the first mounting block comprising a first receiving slot, a first magnet mounted in the first receiving slot; the second mounting block comprising a second receiving slot, a second magnet mounted in the second receiving slot;
wherein the first electromagnet is inserted in the first receiving slot with like poles of the first electromagnet and the first magnet facing each other to generate a first repulsive force which supports the first mounting block, and the second electromagnet is inserted in the second receiving slot with like poles of the second electromagnet and the second magnet facing each other to generate a second repulsive force which supports the second mounting block.

2. The nozzle position adjusting apparatus of claim 1, wherein the rack comprises a supporting plate and a connecting plate connected to the supporting plate, the first electromagnet and the second electromagnet are mounted on the supporting plate.

3. The nozzle position adjusting apparatus of claim 2, wherein a laser module is mounted on the nozzle module, the laser module is adapted to eject laser to the supporting plate and sense light reflected from the supporting plate to get a height of the nozzle module.

4. The nozzle position adjusting apparatus of claim 1, wherein the nozzle module is slidably and rotatably mounted on the shaft.

5. A method for adjusting a position of a nozzle module of a printer, comprising the following steps:
providing a shaft on which is nozzle module is slidably mounted, the shaft comprises a left end and a right end, a first magnet is mounted on the left end, and a second magnet is mounted on the second end; a first electromagnet matches the first magnet and generates a first repulsive force between the first electromagnet and the first magnet, and a second electromagnet matches the second magnet and generates a second repulsive force between the second electromagnet and the second magnet, a laser module is mounted on the nozzle module, the laser module is adapted to eject laser to the printer and sense light reflected from the printer to get heights of the left end and the right end when the nozzle module moves to the left end and the right end;
checking whether the height of the left end of the shaft is proper, if the left end of the shaft is too high, a current supplied to the first electromagnet is reduced to lower the first repulsive force; and if the left end of the shaft is too low, a current supplied to the first electromagnet is increased to raise the first repulsive force; and
checking whether the height of the right end of the shaft is proper, if the right end of the shaft is too high, a current supplied to the second electromagnet is reduced to lower the second repulsive force; and if the right end of the shaft is too low, a current supplied to the second electromagnet is increased to raise the second repulsive force.

6. The method of claim 5, wherein a rack comprises a supporting plate and a connecting plate connected to the supporting plate, the first electromagnet and the second electromagnet are mounted on the supporting plate.

7. The method of claim 5, wherein a first mounting block is mounted on the left end of the shaft, a second mounting block is mounted on the right end of the shaft, a first receiving slot is defined in a first bottom portion of the first mounting block, a second receiving slot is defined in a second bottom portion of the first mounting block; the first magnet is located in the first receiving slot, and the second magnet is located in the second receiving slot.

8. The method of claim 7, wherein the first electromagnet is inserted in the first receiving slot to match the first magnet, and the second electromagnet is inserted in the second receiving slot to match the second magnet.
